(19) United States
(12) Patent Application Publication
(10) Pub. No.: US 2019/0233109 A1
(43) Pub. Date: Aug. 1, 2019

(54) METHOD AND SYSTEM FOR MOVING ITEMS USING AN UNMANNED AERIAL VEHICLE

(71) Applicant: Walmart Apollo, LLC, Bentonville, AR (US)

(72) Inventors: Donald R. HIGH, Noel, MO (US); Robert CANTRELL, Herndon, VA (US); Brian MCHALE, Oldham (GB)

(73) Assignee: Walmart Apollo, LLC, Bentonville, AR (US)

(21) Appl. No.: 16/257,268

(22) Filed: Jan. 25, 2019

Related U.S. Application Data
(60) Provisional application No. 62/624,690, filed on Jan. 31, 2018.

(51) Int. Cl. B64D 1/08; B64C 39/02; G01G 1/26; G01M 1/12

(52) U.S. Cl. CPC B64D 1/08; B64C 39/024; B64C 2201/128; G01M 1/127; G01G 1/26

(57) ABSTRACT

A system and method for moving an item using an unmanned aerial vehicle (UAV) are described herein. The system includes an unmanned aerial vehicle (UAV), and a mechanism attached to the UAV. The mechanism is configured to grab an item located substantially horizontally vis-à-vis the UAV or to a lateral side of the UAV. The mechanism is configured to maintain a balance of the UAV such that a center of gravity of the UAV including the mechanism is located substantially on a vertical line containing an original center of gravity of the UAV without the mechanism.

### CROSS-REFERENCE TO RELATED APPLICATIONS

The present patent application claims priority benefit to U.S. Provisional Patent Application No. 62/624,690 filed on Jan. 31, 2018, the entire content of which is incorporated herein by reference.

### BACKGROUND

### 1. Technical Field

The present disclosure relates generally to unmanned aerial vehicles transport and more specifically to a method and system for moving items using an unmanned aerial vehicle (UAV).

### 2. Introduction

Unmanned Aerial Vehicles (UAVs), commonly known as drones, are becoming ubiquitous. UAVs are increasingly used in aerial imagery and photography, for surveillance, commercial application, real-estate applications, scientific applications, equipment inspections, agricultural applications, military applications, and recreational applications. UAVs are also contemplated as transport vehicles for delivering goods such as packages. An UAV is an aircraft that is piloted without a human pilot aboard the aircraft. The UAV can be operated using a remote control device by a human operator. The UAV can also be operated autonomously by an onboard programmed or programmable computer(s) programmed to execute a specific series of commands or instructions to control the UAV.

UAVs are adapted to reach high places where people require lifts, forklifts, or ladders. Retrieving items or goods from high places using UAVs can be challenging unless the items are located directly under the UAV. However, there are situations where the item to be moved or retrieved by the UAV may be located “horizontally” vis-à-vis of the UAV or the item may be located to a lateral side of the UAV. In this case, the UAV may not be able to retrieve or move the item using current techniques.

Therefore, there is a need for a novel system and method for retrieving or moving an item (e.g., a package) using a UAV wherein the item is located horizontally vis-à-vis the UAV or to a lateral side of the UAV.

### SUMMARY

An aspect of the present disclosure is to provide a system for moving an item using an unmanned aerial vehicle (UAV). The system includes an unmanned aerial vehicle (UAV); and a mechanism attached to the UAV. The mechanism is configured to grab an item located substantially horizontally vis-à-vis the UAV or to a lateral side of the UAV. The mechanism is configured to maintain a balance of the UAV such that a center of gravity of the UAV including the mechanism is located substantially on a vertical line containing an original center of gravity of the UAV without the mechanism.

Another aspect of the present disclosure is to provide a method for moving an item using an unmanned aerial vehicle (UAV). The method includes moving a mechanism attached to the UAV to grab an item located substantially horizontally vis-à-vis the UAV or to a lateral side of the UAV. The method further includes maintaining a balance of the UAV using the mechanism such that a center of gravity of the UAV including the mechanism is located substantially on a vertical line containing an original center of gravity of the UAV without the mechanism.

Additional features and benefits of the disclosure will be set forth in the description which follows, and in part will be obvious from the description, or can be learned by practice of the herein disclosed principles. The features and benefits of the disclosure can be realized and obtained by means of the instruments and combinations particularly pointed out in the appended claims. These and other features of the disclosure will become more fully apparent from the following description and appended claims, or can be learned by the practice of the principles set forth herein. It is to be expressly understood, however, that the drawings are for the purpose of illustration and description only and are not intended as a definition of the limits of the disclosure.

### BRIEF DESCRIPTION OF THE DRAWINGS

FIG. 1 shows schematically a lateral side view of a system for moving an item including a UAV and a mechanism configured to grab an item, according to an embodiment of the present disclosure;

FIG. 2 shows schematically a lateral side view of the system for moving an item including the UAV and the mechanism extending to grab the item, according to an embodiment of the present disclosure; and

FIGS. 3 and 4 show schematically a front view of the system for moving an item including the UAV and the mechanism for grabbing the item, according to an embodiment of the present disclosure.

### DETAILED DESCRIPTION

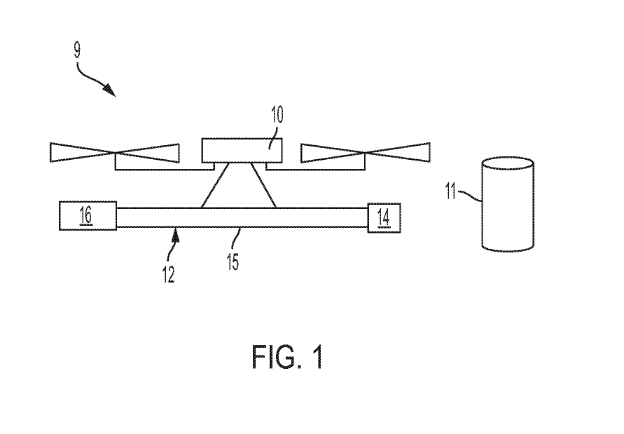

FIG. 1 shows schematically a lateral side view of a system for moving an item including a UAV and a mechanism configured to grab an item, according to an embodiment of the present disclosure. As shown in FIG. 1, the system 9 for moving an item includes a UAV 10 and a mechanism 12 configured to grab an item 11, for example to retrieve and move the item 11. The mechanism 12 is attached to the UAV 10. The mechanism 12 is configured to grab item 11 located substantially horizontally vis-à-vis the UAV 10 or to a lateral side of the UAV 10. The mechanism 12 is configured to maintain a balance of the UAV 10 such that a center of gravity of the UAV 10 including the mechanism 12 is substantially on a vertical line containing an original center of gravity of the UAV 10 without the mechanism 12. In an embodiment, the mechanism 12 includes a paddle-type item grabber 14. An example of a paddle-type item grabber is described in U.S. Provisional Patent Application 62/611,775, filed on Dec. 29, 2017, the entire content of which is incorporated herein by reference. However, according to an aspect of the present disclosure, the mechanism 12 further includes a counterweight system 16. The counterweight system 16 is configured to counterbalance a weight of the item 11 so that a center of gravity of the UAV 10 with the mechanism 12 attached to the UAV 10 is maintained substantially on a vertical line containing the original center of gravity of the UAV 10 when the mechanism 12 is not attached to the UAV 10. The counterweight system 16 is linked to paddle-type item grabber 14 via linkage system 15.

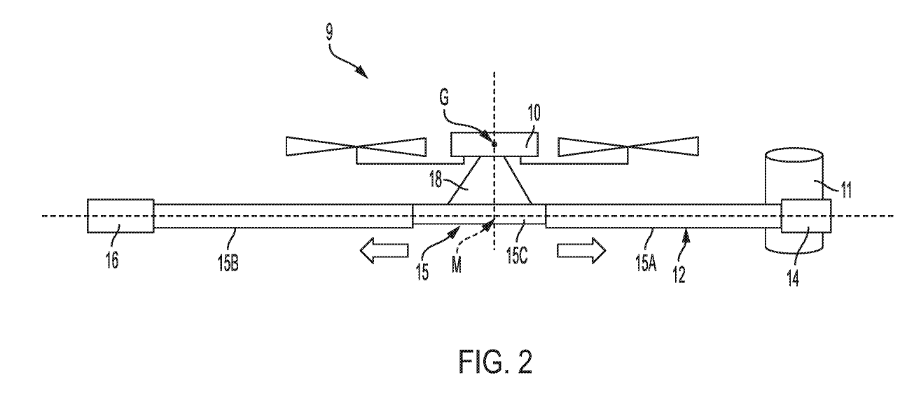

FIG. 2 shows schematically a lateral side view of the system for moving an item including the UAV and the mechanism extending to grab the item, according to an embodiment of the present disclosure. As shown in FIG. 2, the mechanism 12 is configured to extend so as to bring the paddle-type grabber 14 in contact with the item 11. In an embodiment, the mechanism 12 can extend by extending the linkage system 15. In an embodiment, the linkage system 15 includes a first movable arm 15A linked to the paddle-type grabber 14 and a second movable arm 15B linked to the counterweight system 16. A connector 15C is provided that connects the first arm 15A and second arm 15B to the UAV 10. The connector 15C is mounted to the UAV 10. For example, the connector 15C is mounted through support members (e.g., legs) 18.

As the mechanism 12 extends forward to move the paddle-type grabber 14 towards the item 11 to retrieve the item 11, the counterweight system 16 extends backward. The paddle-type grabber 14 is moved towards the item 11 by extending the first movable arm 15A of the linkage system 15 forward towards the item 11. The counterweight system 16 extends backward by extending the second movable arm 15B of the linkage system 15 in the opposite direction to maintain balance of the mechanism 12. During the movement of the first movable arm 15A and the second movable arm 15B in opposite direction, the first movable arm 15A and the second movable arm 15B remain connected to each other and to the UAV 10 through connector 15C. The movement of the first movable arm 15A and the second movable arm 15B can be controlled using a servomotor that is controlled by the on-board computer of the UAV 10.

In an embodiment, as the paddle-type grabber 14 clamps the paddles to the sides of item 11 to retrieve the item 11, the counterweight system 16 is moved accordingly to counter a weight of the item 11. In an embodiment, the weight of the item 11 is known in advance and is entered in advance to the on-board computer of the UAV 10 (e.g., using a remote controller or the like). For example, data about a weight of the item 11 can be stored in a database and provided to the UAV on-board computer. In another embodiment, the UAV 10 can read a label containing a marking (e.g., a barcode) provided on the item 11, for example, using a camera or using a laser provided on the UAV 10. The marking can contain information regarding the weight of the item 11. In yet another embodiment, the weight of the item 11 can be determined by an internal scale(s) on a shelf holding the item 11. Since the UAV 10 knows or can read a weight of the item 11 it is picking or retrieving, the on-board computer of the UAV 10 can control the servomotor to move the counterweight 16 to adjust for the weight in advance before lifting or displacing the item 11.

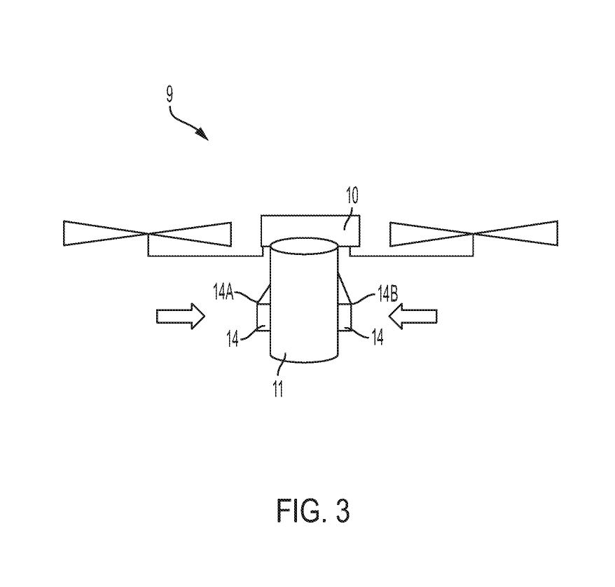

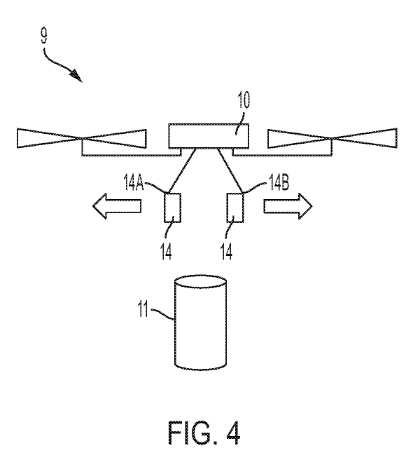

FIGS. 3 and 4 show schematically a front view of the system for moving an item including the UAV and the mechanism for grabbing the item, according to an embodiment of the present disclosure. As shown in FIG. 3, the paddle-like grabber 14 clamps the item 11 to grab the item 11. As shown in FIG. 3, the arrows indicate a relative movement of two contact paddles 14A and 14B of the paddle-like grabber 14 towards the item 11 during a grabbing phase. As shown in FIG. 4, during a release phase, the contact paddles 14A and 14B of the paddle-like grabber 14 move in a direction opposite to the direction shown in FIG. 3. As shown in FIG. 3 and FIG. 4, the contact paddle 14A and the contact paddle 14B of the paddle-like grabber 14 move in opposite directions relative to each other during both the grabbing phase (shown in FIG. 3) and during the release phase (shown in FIG. 4). In an embodiment, the movable arm 15A connected to the contact paddles 14A and 14B and the movable arm 15B connected to the counterweight 16 are configured to move (e.g., slide) independently from each other.

In an embodiment, counterbalancing using the counterweight 16 on the opposite side of pickup contact paddles 14A and 14B allows the UAV 10 to pick up items via the contact paddles 14A and 14B when the UAV is horizontal vis-à-vis of the item 11. The term “pickup contact paddle” is used herein to refer to any configuration that is adapted to contact a surface of item 11 to hold the item 11 by pressure, stiction, friction, lift or the like. The contact paddles 14A and 14B may include suction cups, stiction pads, claws, scoops, etc. The contact paddles 14A and 14B can be made from many materials including, but not limited to, rubber, plastic, metal, wood, or a composite material, or any combination thereof. The pickup contact paddles 14A and 14B may have a rough surface to increase friction and thus enhance a holding strength on the item 11. In an embodiment, the pickup contact paddles may carry sensor units so that the UAV 10 can both be used as a sensor carrier or an item carrier, or both. In an embodiment, the paddles 14A and 14B can be configured to grab rechargers and hold for battery recharging.

The counterweight 16 counterbalances the weight of the item 11 to maintain the center of gravity of the UAV 10 substantially within the UAV (or in a vertical line containing an original center of gravity of the UAV 10 with no additional weights). This can be achieved when, for example, the moment of force generated by the counterweight 16 and the moment of force generated by the item 16 are equalized or balanced. The moment of force generated by the counterweight 16 is equal to the weight (Wc) of the counterweight 16 multiplied by a distance from the center of gravity of the counterweight 16 to a midpoint M (shown in FIG. 2). The moment of force generated by the item 16 is equal to the weight (Wi) of the item 11 multiplied by a distance from the center of gravity of the item 11 to the midpoint M. The midpoint M is located at the intersection of a vertical line containing the original center of gravity G of the UAV 10 and a line linking the two movable arms 15A and 15B. The distance between the center of gravity of the counterweight 16 to the midpoint M and the distance between the center of gravity of the item 11 to the midpoint M can be adjusted to equalize or balance the momenta of force and thus maintain the center of gravity of the UAV 10 as desired such that the center of gravity of the UAV 10, including the mechanism 12 carrying the counterweight 16 and the item 11, is located substantially within the vertical line containing the original center of gravity G of the UAV 10 without the mechanism 12.

In an embodiment, as the UAV 10 picks up or drops off object, the counterweight 16 is immediately adjusted or moved, for example, by adjusting the distance between the center of gravity of the counterweight 16 and the midpoint M. In an embodiment, the counterweight 16 attached to the movable arm 15B arm may be heavier than the pickup or contact paddles 14A and 14B. The counterweight 16 slides outwardly and inwardly at different weights. As a result, the difference in the mass and the distance of extension provides the information on the counterweight force being used. In an embodiment, the counterweight 16 and pickup paddles 14A and 14B are configured to move independently so that the counterweight 16 can be moved to a distance as needed to handle the addition or loss of weight of the item 11. In an embodiment, the movement of the counterweight 16 is controlled based on stability sensors in the UAV 10, for example, whether the UAV is level and in what direction it is unbalanced. In an embodiment, the paddles 14A and 14B, the counterweight 16 and movable arms 15A and 15B can be configured to rotate without the whole UAV 10 rotating (e.g., such as in turret-style). In another embodiment, the direction of the arms 15A and 15B can be fixed in space and the UAV 10 is allowed to rotate.

In another embodiment, the counterbalancing feature can be achieved with or without using the counterweight 16. For example, the counterbalance can be achieved by changing rotor speeds of the UAV 10 in lieu of or to supplement the use of counterweight 16 and movable arms 15A and 15B. In an embodiment, propellers of the UAV 10 can counteract unbalanced loads by speeding up or slowing down rotations of the propellers.

In an embodiment, the items including item 11, for example, can be arranged or grouped according to weight handling limits of paddles 14A and 14B of UAV 10. In an embodiment, robots or movement assisting units can be provided on shelves to push items forward or toward otherwise optional pickup spots where the UAV 10 can perform the pickup. Although, a pickup operation is described in the above paragraphs, the UAV can also perform a similar counterbalancing operation by moving the arms 15A and/or 15B or changing the rotation of the propellers when the UAV 10 is used to put items on the shelves in a shelf restocking operation.

In an embodiment, a net may be provided under the UAV 10 and shelf. The net may be attached to the UAV 10. A pocking arm provided on the UAV 10 can be configured to push an item over the edge of the shelf into the net. In this way, the item will land on the net and can be safely lowered to the ground.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A system for moving an item using an unmanned aerial vehicle (UAV), the system comprising:
an unmanned aerial vehicle (UAV); and
a mechanism attached to the UAV, the mechanism including a grabber configured to grab an item located substantially horizontally vis-à-vis the UAV or to a lateral side of the UAV and a counterweight system configured to counterbalance a weight of the item;
a first movable arm linked to the grabber and a second movable arm linked to the counterweight system; and
wherein the mechanism is configured to maintain a balance of the UAV such that a center of gravity of the UAV including the mechanism is located substantially on a vertical line containing an original center of gravity of the UAV without the mechanism, wherein the first movable arm is configured to extend to move the paddle-type grabber in a first direction to grab the item and the second movable arm is configured to extend the counterweight system is a second direction opposite to the first direction, and
wherein the counterweight system and the paddle-type grabber are configured to move independently so that the counterweight is movable to a distance as needed to handle an addition or loss of weight of the item.

2. The system according to claim 1, wherein the grabber comprises a paddle-type grabber configured to grab the item.

3. The system according to claim 1, further comprising a scanner to read a label of the item.

4. The system according to claim 2, wherein the mechanism is configured to extend to move the paddle-type grabber to grab the item.

5. The system according to claim 4, wherein the mechanism further comprises a connector connected to the UAV and configured to connect the first arm and the second arm.

6. (canceled)

7. The system according to claim 1, wherein the weight of the item is stored on an on-board computer of the UAV.

8. The system according to claim 1, wherein the weight of the item is stored in a database accessible to an on-board computer of the UAV.

9. The system according to claim 1, wherein the weight of the item is read from a label provided on the item, the label having a marking containing information associated with the weight of the item.

10. The system according to claim 1, wherein the weight of the item is determined by an internal scale on a shelf holding the item.

11. (canceled)

12. The system according to claim 1, wherein a movement of the counterweight system is controlled based on stability sensors provided on the UAV.

13. The system according to claim 2, wherein the paddle-type grabber comprises a plurality of contact paddles configured to contact a surface of the item to hold the item.

14. The system according to claim 13, wherein the plurality of contact paddles are configured to hold the item using pressure, stiction, friction, lift, or any combination thereof.

15. The system according to claim 13, wherein the contact paddles comprise suction cups, stiction pads, claws, scoops, or any combination thereof.

16. A method for moving an item using an unmanned aerial vehicle (UAV), the method comprising:
moving a mechanism attached to the UAV to grab an item located substantially horizontally vis-à-vis the UAV or to a lateral side of the UAV;
maintaining a balance of the UAV using the mechanism such that a center of gravity of the UAV including the mechanism is located substantially on a vertical line containing an original center of gravity of the UAV without the mechanism, and;
reading by the UAV a weight of the item from a label provided on the item, the label having a marking containing information associated with the weight of the item.

17. The method according to claim 16, wherein moving the mechanism comprises extending a first movable arm attached to a paddle-type grabber for grabbing the item in a first direction, and maintaining the balance of the UAV comprises extending a second movable arm attached to a counterweight in a second direction opposite to the first direction to counter a weight of the item.

18. (canceled)

19. The method according to claim 16, determining a weight of the item using an internal scale on a shelf holding the item.

20. The method of claim 16, further comprising changing rotor speeds of the UAV to supplement the use of counterweight.
